(19) United States
(12) Patent Application Publication
(10) Pub. No.: US 2006/0038672 A1
(43) Pub. Date: Feb. 23, 2006

(54) System and method for delivery and management of end-user services

(75) Inventor: Roland Schoettle, Glen Cove, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Optimal Licensing Corporation, Calgary (CA)

(21) Appl. No.: 11/172,615

(22) Filed: Jun. 30, 2005

Related U.S. Application Data
(60) Provisional application No. 60/585,557, filed on Jul. 2, 2004.
(60) Provisional application No. 60/591,265, filed on Jul. 26, 2004.

(51) Int. Cl. G08B 19/00; G08B 1/00

(52) U.S. Cl. 340/522; 340/531

(57) ABSTRACT

The present invention is directed to a system and method which allows each end-user (or a combined number of end-users) to set controls for each of the user's energy using systems at one or more premises. Each end-user, for each premise, then can determine, based on a digital copy of a holistic view of the premise, how it will manage the premises. In one embodiment, this system and method ties into a network of sensors which, in turn, is tied into a larger service network that controls the distribution system services throughout a wide area. In operation, in one embodiment, sensors associated with each system, appliance, or piece of equipment on a premise feeds data back to a main control unit serving that premise or the plurality of premises so as to form the digital copy. The digital copy can also be fed to larger nodes which, in turn, can feed the data to the wide area service

### PRIORITY

This application claims priority benefit of U.S. Provisional Patent Application No. 60/585,557 entitled “SYSTEM AND METHOD FOR MANAGING POWER END-USER DISTRIBUTION,” filed Jul. 2, 2004, and Provisional Patent Application No. 60/591,265 entitled “SYSTEM AND METHOD FOR MANAGING POWER END-USER DISTRIBUTION,” filed Jul. 26, 2004, the disclosures of which are hereby incorporated herein by reference.

### TECHNICAL FIELD

This disclosure relates to end-user system control and more particularly to systems and methods for delivery and management of end-user services, and even more specifically to such systems and methods that include controlling power distribution to end-users.

### BACKGROUND OF THE INVENTION

End-user services come in many forms. There are electric utilities, water utilities, cable providers, sewer and steam providers, wireless and wireline communications, emergency monitors and responders, remote computer processing, to name just a few. All of these service providers deliver their product to (and sometimes receive product or information from) end-users at a premise or group of premises. Note that the concept of ‘premise’ and ‘premises’ is used interchangeably herein and includes, without limitation, a single home, a business, a building, a factory or other facility, grounds, vehicles, containers, industrial plants, treatment facilities, stadiums, parks, farms, etc. and includes combinations, aggregates or portions thereof. Some of these premises are used for delivering services and some for receiving services, but each of the premises can be either an end-user of services or a provider of services or both.

When services are provided to a premises it is important to be able to measure (both by the service provider as well as the end-user) the quality and quantity of the product. In some cases it is important for the service provider, as well as the end-user, (who could be a single entity or a group of entities, such as a coop, condominium association, a business, etc) to be able to observe and/or control the provision of services to a premises and this observation should include being able to ‘tune’ or tailor the premises use of the services (or the service providers use of the information coming from the end-user) to an ever changing environment.

It is also necessary for the service provider, or group of providers to be able to “observe” its own delivery of services, both to an individual user as well as to a group or groups of users, (sometimes spread over a large area) so as to be able to properly deliver and account for the service provider's product. Such observation may consist only of confirmation of normative or expected delivery and product use, but may be of particular value, for example, when a service is in short supply, or time is of the essence for service delivery. In such cases it is important for the service provider to obtain feedback either as to confirmation of expected delivery or use at the premises or as to how the premises is responding to normal and abnormal conditions and as to how the premises complied with a particular request. Abnormal conditions can be caused by the service provider, or user, or by the premises itself. It is also necessary to measure and verify “compliance” by the end-user to the service agreement (e.g., if a user complied to the request to reduce energy or not).

By way of example, electricity is a peculiar product. It drives virtually all aspects of the services that define modern life yet it cannot be easily stored directly, is extremely susceptible to degradation of quality, and is the only product that is consumed continuously within a tenth of a second of its production by all customers. Its cost, quality, and reliability are critical for the modern digital economy and the services expected from it. For these reasons its cost is highly dependent on generation, transmission, and distribution system constraints caused by a change in load at time of use.

Power generation and delivery include complex relationships involving, for example, frequency, voltage, and active and reactive power, all of which must track the changing load exactly to avoid catastrophic consequences. Because load changes constantly, it affects operating and generator fuel requirements, costs, system efficiencies, grid constraints, power quality, and reliability which in turn affect environmental concerns such as air emissions, water use for power generation or cooling, and land use.

These physical properties result in a product whose marginal cost of production, margin cost of quality, and marginal cost of reliability fluctuate rapidly and therefore whose delivered cost also fluctuates rapidly. Even where power quality cannot be maintained, no other product has a delivered cost that fluctuates nearly so rapidly or so severely.

The problem is very significantly worsened and can not be thoroughly solved because the demand-side customers cannot respond to real-time fluctuations in the delivered cost of power. Because demand is unable to respond to price, the supply and demand curve may fail to intersect, a market flaw so severe it is not contemplated by standard economic theory. There are three primary reasons for this:

Lack of Real-Time Billing: Real-time billing requires real-time measurement of sufficient parameters as well as the communications infrastructure to send real-time information. Lack of real-time billing causes a lack of demand responsiveness to price because people do not see price fluctuations at the time of use. Within the practice of economics this is called “demand inelasticity”. It is important to note that adding new real-time meters without adding real-time customer-directed, system-level, device-level, and/or appliance-level automated load management does little to help demand-side responsiveness.

Lack of Real-time Control of Power Usage to Specific Loads and/or Services: Real-time control of power flow to specific customers requires real-time metering, a secure bi-directional communications infrastructure, and remotely verifiable device-level or service-level connect and disconnect functionality. Lack of real-time control of power to specific customers devices and/or services prevents physical enforcement of bilateral contracts and results in the system operator being the default supplier in real-time. The system operator is then forced to set the price.

Lack of Real-Time Customer-Controlled, Automated Power Consumption Management Within the Premise: Real-time customer controlled automated power management requires real-time metering and sub-metering for every significant load, and/or service, secure bi-directional communications between loads and customer, and a method of automating customer response preferences. Lack of real-time, customer-controlled, automated power management within the premise causes a lack of demand response because people cannot be expected to spend their time watching a real-time meter and then scurrying to manually adjust services and /or load settings elsewhere.

Because customers cannot respond, the economic ripple-effect is much more disastrous than at first appearance. Without a fully functional demand-side, elasticity-based price spikes cannot directly address power quality solutions (which are critically needed for digital electronics/services to function properly) or correctly determine new investment. There is growing evidence that regulators are seeking to develop fully-functioning, competitive markets by encouraging a responsive and unfrozen demand-side.

It had been long thought that gathering power distribution information was not practical for big power distribution systems. Such power distribution information could, for example, include the power factor of a given neighborhood, the voltage levels, impedance and current draw of specific locations, etc. However, since most power problems actually begin in specific areas and involve the distribution system, the system requires information about the network that is not available today. Because of the lack of information coming specifically from users devices and services, the problem is seen only as noise to the operators of a power company at a central location. By the time the effects of the “problem” ripple to the central control, the problem is often magnified leading to difficult situations.

Therefore, assuming that an application exists at a central control point that can use very specific power distribution information gathered from across the system so as to determine where generation resources should be added or subtracted, or to determine, what kinds of loads or capacitor bank settings are needed and the like are needed. Then the need exists to be able to efficiently generate such information from various locations. Once such information is generated it must then be distributed to the places of control for further device- and service-level management.

A further problem exists in situations where it is necessary to reduce power consumption for periods of time. One concept for achieving such reduction is to change the cost of consumed power as usage (delivery costs) increases. Thus, as power consumption increases through the day, the cost to the user increases as well. Since per minute billing is contemplated, the user needs to know the current power price so the user will shed load. In concept this sounds good, but in reality it is difficult to achieve and the results are often arbitrary. Under such a plan, some users will be concerned, while others might not be. Some will turn off HVAC services such as air conditioners, while others might turn off lighting related services. In the end, such arbitrary shedding could actually cause more distribution problems then are solved. For example, so many people could turn off their air conditioners that so much power would be saved that one or more generators could go off line thereby prolonging the power shortage problem instead of fixing it. Thus, the system could shed power just when it needs it the most.

Some experts believe that the best approach to system-wide load management is to equip every business and home with automated thermostats and real-time metering. The idea is to send a price signal to all pre-programmed thermostats in the desired geographic region in the hope that they respond correctly by turning off central air conditioners and therefore significantly reduce load on the grid. Verification of load reduction is accomplished by synchronized reading of the main meter at the time of the load reduction. In addition to the fact that this approach only targets central air conditioning units and thereby avoids lighting and other large loads which are often beneficial toward conservation efforts, the available evidence suggests that the “smart” thermostat approach likely will not provide the desired benefits.

Programmable thermostats have been around for over 20 years, with millions sold. Yet very few are used to automate energy conservation and are instead used simply as manual thermostats with digital readouts. Because other loads are not orchestrated with the thermostat, and because other loads can start and run while the higher price signal is being sent to the thermostat, there is no way to verify or accurately predict the specific amount of load being shed by the price signal when it is most needed and no way to know the real effects of using only a thermostat-base load shed system. Because there is no submetering at the air conditioning unit in this approach, and therefore no direct verification that load was shed because of direct interaction with the thermostat by the end-user, some of the direct reward to the end-user is lost as is end-user motivation to participate.

Further, the end user does not see the real benefits of the thermostat approach and cannot see that other significant loads that also should be simultaneously managed to meet the objective of real-time pricing. Historically, such marginal approaches have failed, marring other approaches toward the same goal. Further, many end-users, especially at the residential level, will need to understand a lot more about real-time prices, how they effect the monthly bill, and what to do to set the thermostat. These are often the very same users that have difficulty programming a VCR. Regardless, many experts believe that users, the majority of which are unsophisticated, will respond by correctly selecting thermostat-only based price points that will reduce response oscillation.

### BRIEF SUMMARY OF THE INVENTION

The present invention is directed to systems and methods which allow each end-user (or a combined number of end-users, herein called premises) to set and operate controls for each of its energy using services, systems, devices and/or appliances. Each premise then can determine, based on signals supplied from a central control point, how it will manage its power consuming services, systems, devices, and/or appliances. In one embodiment, this system and method ties into a network of sensors which, in turn, is tied into a larger network that controls the distribution system throughout a wide area. In operation, in one embodiment, sensors associated with each service, system and/or piece of equipment on a premise feeds data back to a main control unit serving that premise so as to form a digital copy of the premise. This digital copy is used to control power, and other service parameters, of the premise. In one embodiment, the digital copy is also fed to larger nodes which, in turn, can feed the data to the wide area network. In this manner a digital copy of many premises is achieved.

Upon a signal from the central control source (for example, to reduce power by 10%), each premise control unit then looks to the digital copy of the premise (as obtained from the various services and/or devices associated with the premises and makes decisions as to what would be the best way for that control unit to effect the desired reduction at this time. At the same time, the action(s) taken (and to be taken) is fed back to the main network for use in further determining whether the overall system has accomplished its goals. When it has, the system instructs subsequently reporting controllers to not take the action contemplated or to reverse (or reduce or otherwise alter) an action already taken. This then achieves interactive management of the power distribution system with respect to the overall system and with respect to a particular premise and reduces oscillation in the network.

In a further embodiment, the premise system has sensors in various rooms to keep track of all the parameters occurring in the room. Accordingly, if, for example, a sensor has not detected motion for a period of time the assumption can be made that a room, or set of rooms, is unoccupied. Lighting and/or HVAC service (lights, heating, cooling, for example) can be reduced in those rooms without any undo distress. Other services could include metering and sub-metering, energy management, security monitoring, safety monitoring, fire protection/monitoring, medical monitoring, wireless communications, telephone, premise (home) automation, equipment monitoring, data storage, surveillance monitoring, digital entertainment, etc. Thus, the power-using environment can be tailored to the user and/or the actual use of the premises while conserving energy. In this respect the system makes what is effectively a digital copy of each premise location and then utilizes that digital footprint for service and control purposes. As will be discussed in more detail with respect to FIG. 7, once the system is deployed for a single service (say, electrical utility) then additional services can be overlaid often without additional sensors or controllers.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a power distribution system having central control;

FIG. 2 shows an alternate embodiment of a power distribution system having central control;

FIG. 3 shows one embodiment of a local control system;

FIG. 4 shows one embodiment of an individual control circuit;

FIG. 5 illustrates one embodiment of a system having modular robots (or modbots) connected to various premise control points for enabling and directing various services;

FIG. 6 depicts a block diagram of a computer system which is adapted to use the present invention; and

FIG. 7 depicts one embodiment of a platform for the unification of multiple services for a premises.

### DETAILED DESCRIPTION OF THE INVENTION

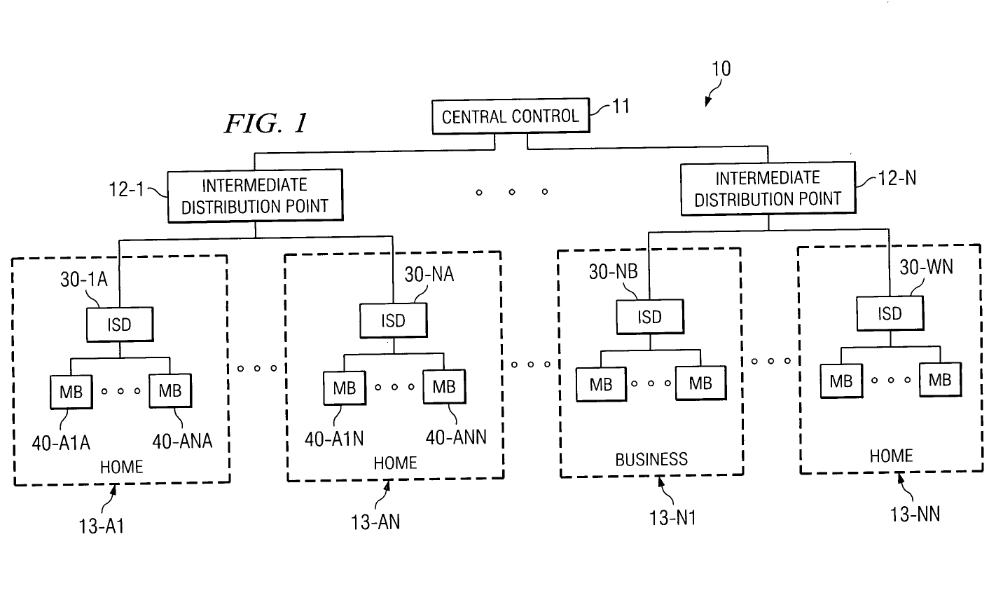

FIG. 1 shows one embodiment 10 of a power distribution system having central control 11 which gathers information from (and sends information to) intermediate distribution points, such points 12-1 to 12-N. These distribution points, in turn, send and receive information to and from each premise, such as premises 13-A1 to 13-AN and 13-N1 to 13-NN. Intermediate distribution point 12-1 would then communicate with a large number, perhaps 4,000 or more, premises. Within each premise, an intelligent services director (IDS) such as ISD 30—would be the central gateway for assembling and maintaining a digital copy of that premise's environment. That information (i.e., the digital copy of the environment) is stored with the ISD and also transmitted to the intermediate distribution point serving that ISD. Such communication could be via several modes of communication, such as, for example, 802.11, Internet, modem or cell phone, etc. Also note that there could be several levels of intermediate distribution points serving a particular residence or premises.

The ISD communicates with a device, herein called a modular robot (modbot), such as MB 40-A1A and 40-ANA is, for example, using redundant power line communications and/or 900 megahertz ISM band RF communications, etc. The modbots which can be plug and play in one embodiment, produce a mesh network that allows information to hop and skip between modbots and any ISD with which it is properly identified. Likewise the ISD can use the modbot to hop and skip to find a specific modbot in the network. This is done in cases where a particular communications approach based on a single communications medium or a simple combination of multiple mediums (e.g., both RF and power line communications do not reach a particular modbot directly. A combination of two or more modbots can be used to communicate with a specific modbot, if required.

A variation of this system can be used in cases where the premise does not have a high speed Internet connection. A meter director located at the transformer can be used to service a small area of perhaps, eight or more premises. Within the premise, the ISD can, if desired, provide high speed Internet access if the premise does not already have such. The ISD can also provide many other features and services.

As will be seen, all management is achieved in the context of user requirements as set by each user using real, well understood ambient and electrical intelligence from the local site. The sensors measure and report time-stamped data that can include voltage, current, frequency, impedance, active and reactive power, energy consumption, and accumulated device, system, and/or appliance operation (collectively, “electrical parameters”), and for temperature, light, motion, sound, Global Positioning system (GPS) location, occupancy, biometrics, medical monitoring, humidity, radiation, hazardous chemicals and gases, pollutants (vapor, chemical, particle, gas, etc.), materials residues, entertainment systems, smoke and fire detection, water flow, water presence, among other optional measurements. These sensor readings allow, for example, the temperature in an air conditioned room to rise to a user-predetermined level before cooling again, and then only in occupied rooms during predetermined time periods. Intelligent, optimized, control interaction and networking ensures that controls do not operate in a conflicting manner (e.g., the air conditioner is cooling at the same time the furnace is heating, or water is turned off if a legitimate higher priority need exists for water within the premises).

Note that while not all sensor/controllers need have all of the possible detectors, each particular premise would, in all probability, use modbots having the same, sub-set of measured parameters, tailored to that premise, or that premise type.

These more highly-differentiated, detailed responses, all subject to user-specified and authorized constraints, assure a level of detail from a large number of systems and devices that, when analyzed and optimized, “dampens” system and market oscillations that might otherwise result from homogeneous user-responses to single price signals, while lowering energy costs. The use of a robust, high speed, bi-directional network and communication technology, coupled with advanced analysis, optimization and control technology, allows an accurate predetermination of available and manageable resources, easy deployment of a wide variety of services based on a common platform, as well as large-scale aggregation and management of an optimized combination of systems and services.

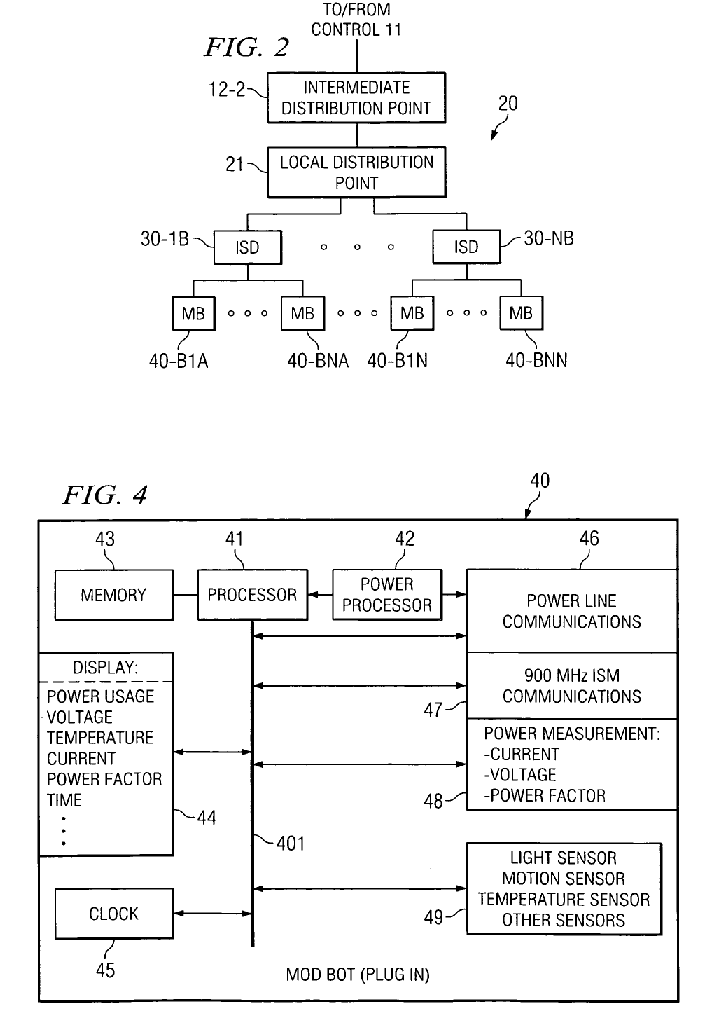

FIG. 2 shows an alternate embodiment 20 of a power distribution system having central control, and having local distribution point 21 connected to the intermediate distribution point 12-2. This connection can be via modem or cell phone or 802.11, Internet or the like.

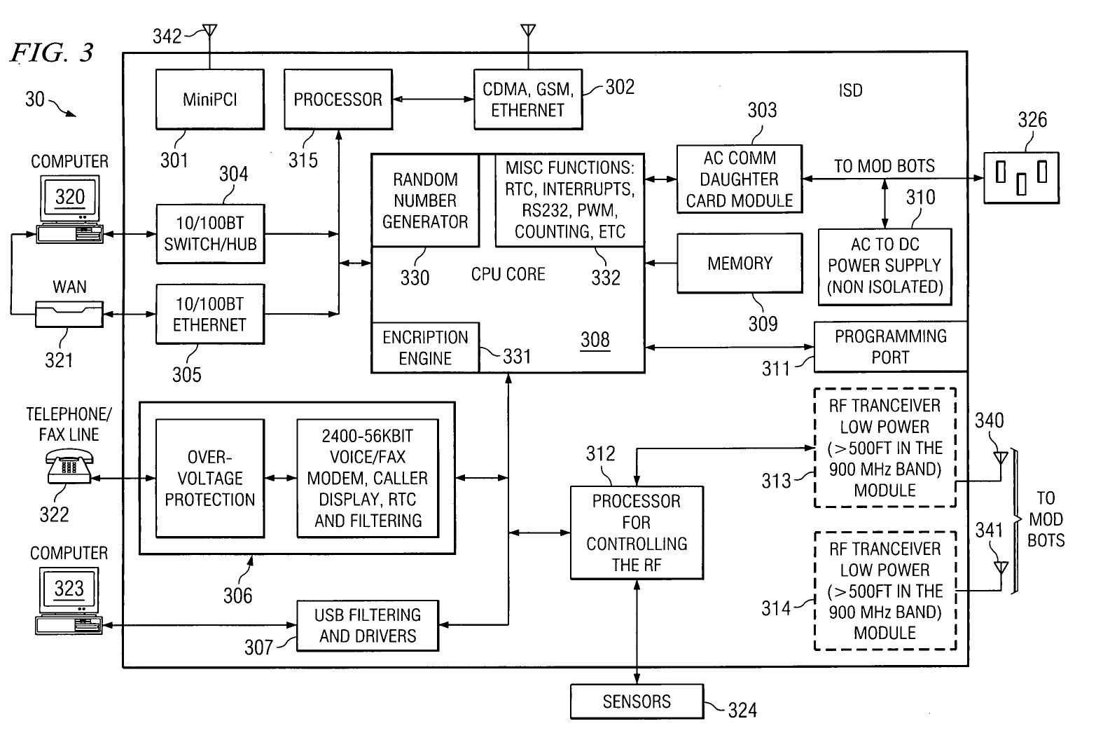

FIG. 3 shows one embodiment 30 of a local control system, (ISD) such as system 30-1 which, as discussed above, provides a digital copy of the premise covered by system 30-1 (FIGS. 1 and 2) to central control via one or more intermediate distribution points. The ISD has several expansion capabilities, such as PCI connectors (such as connectors 301) that are used for any number of PCI cards that are available as plug-in expansions for functionality to the ISD, for example, via antenna 342. One such example of this communication would be the 802.11 standard for communicating with local distribution point 21 (FIG. 2). Another example would be a voice over IP usable with a local LAN or WAN (element 321) network (elements 304 and 305) or with a USB port (element 307) to a computer(s) such as computer 320 or computer 323. Other circuits provide various other modes of communication, such as fax and/or telephone for backup communications in the event of a failure of a data connection. If desired, a camera can be connected. Also, if desired, a RJ45 (or other type) module can be provided to allow legacy connections to a revenue grade meter.

Note that while system 30-1 is shown communicating with intermediate point 12-1 (FIG. 1) it should be understood that the ISD can control the premise to which it is associated without communication to or from any other system or network. Also, ISD 30-1 can, if desired, communicate directly with one or more other ISDs. The system can, if desired, have override capability for use by the end-user (with authorization, if required) for any defined condition or to override a set of instructions coming from an external, or even an internal, source. For overrides pertaining to a service provider the service provider could be notified that the end-user has authorized override to a previously defined condition. In this way the end-user can, if desired, maintain full and primary control of their premises. The override can be manually activated at one or more of the modbots and/or at the control unit. The override can be a physical button, an input device (keypad), a communication link or could be voice activated.

Processor 312 (FIG. 3) provides control for RF transceivers 313 and 314 to and from the modbots, as well as handling sensors (such as third party sensors). These sensors can be, for example, motion sensors, glass break sensors, window and door sensors and the like. Transceivers 313 and 314 are, for example, 900 megahertz ISM transceivers. One can be used for regular communications and the other can be placed into receive mode for emergency communications if a modbot or other device needs to communicate with the ISD immediately. Memory 309 consists of both volatile and non-volatile memory and holds the data, settings and applications including the digital copy of the premises for controlling the ISD in cooperation with control 308 and/or processors 315 and 312.

The ISD can be upgraded via its wide area connections, or via port 311, if a program upgrade exists and it receives this from either the local distribution point or the intermediate distribution point or from a user. Power is supplied via power supply 310 and AC power line communications for connection to the modbot within the premise is controlled by circuit 303. CDMA or GSM module 302 is used for wide area connections or emergency connection to fire, police and the like. Processor 315 provides communications control to assist CPU 308. This function could, if desired, be handled by processor 308 or by a processor internal to each communication device. CPU 308 is the main processor to the system and includes random number generator 330, encryption engine 331 and other multiple functions 332. This processor, in one embodiment, handles communications throughout all devices, including interrupts, as necessary, and all programming.

FIG. 4 shows one embodiment 40 of an individual control element, such as plug-in modbot 40-A (FIG. 1). Inside modbot 40—is main processor 41, as well as, memory 43 and power processor 42. Memory 43 can hold, for example, a digital copy of the environment if the modbot and/or a full digital copy of the premises as well as data necessary for control of the modbot. Modbot 40 can be remotely upgraded with a program upgrade via an ISD (FIG. 3) which in turn receives its information from an intermediate distribution point. Display 44 displays the necessary vital information to the user of the device in visual format and can, if desired, display a digital copy of the premises, if desired, to service providers and/or others in a hierarchical chain. Thus, a user can “see” a unified whole and can take any desired action. This information includes clock 45, as well as many other displays. Power line communication is controlled by circuit 46, (which communicates with element 326, or an equivalent thereof, FIG. 3) while 900 megahertz transceiver 47 also communicates with the ISD via elements 313 and 314, FIG. 3. Power measurements are controlled by circuit 48 and these include electrical parameters, such as power usage, current, voltage, impedance, and power factor. Sensors are contained within the modbot as shown by element 49. Examples of these are sensors for electrical parameters, temperature, light, motion, GPS location, occupancy, biometrics, medical monitoring, humidity, radiation, hazardous chemicals and gases, pollutants (vapor, chemical, particle, gas, etc.), material residues, entertainment systems, smoke and fire detection, water flow, water presence, and the like.

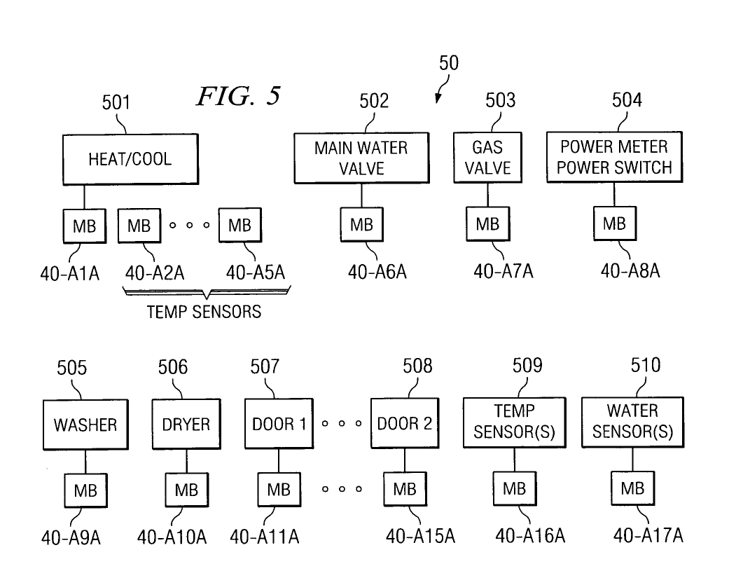

FIG. 5 illustrates one embodiment of a system, such as system 50, having sensors, such as modbots 40-A1A through 40-A17A, connected to various premises equipment and service (utility and otherwise) control points, such as points 501-510. System 50 is meant to be illustrative only and shows only a small possibility of controllable parameters. Note that in many situations the modbots would have the measurable parameter (and a controller) built within the modbot and thus separate sensors or control elements would not be necessary. For example, modbot 40-A16A shown associated with temperature sensor 509 might, in fact, have temperature (or other sensors) built into it. Thus, in some cases the modbot would have the sensor as part of its internal structure and at other times the modbot might be connected to one or more specialized sensors. It is anticipated that the sensors for common parameters, such as temperature, light level, motion, GPS location, biometrics, medical condition detection, entertainment, fire detection (including rate of rise, absolute temperature, products of combustion), etc. would be built into all or most of the modbots. For other parameters, such as hazardous chemicals or gases, radiation, pollutants (vapor, chemical, particle, gas, etc), humidity, water flow or water presence, etc, the sensors would be separate or the modbot would be a specialized modbot. Similarly, certain utility controls, such as controls 503, 504, would most probably be specialized modbots, or specialized switches or sensors connected to one or more modbots. Note that in the context of this application, utility can be, for example, a governmental body, a private or public benefit corporation or other entity, such as a homeowners association, a cooperative, or part of a building and would include service, procurement, sale, and/or management of power, gas, steam, water, sewer, telephone, cable, fiber, building management services, security services, medical monitoring services, wireless, and the like shared or aggregated among a number of users/customers/sellers.

In a typical premise today for heating and control purposes (HVAC service) there would be a plurality of thermostats spaced in different rooms or in different parts of the premise, each arranged for sensing temperature and for individually sending signals to one or more central heating/cooling devices, such as device 501, for the purpose of controlling the temperature, for example, by turning the heating/cooling on or off at one or more zones. While the arrangement contemplated herein could, in fact, be set up in such a mode, the more likely arrangement would be for a single modbot (such as modbot 40-A1A) to be assigned to each (or to a plurality of) heating/cooling device(s) 50 and for separate modbots, such as modbots 40-A2A though 40-A5A, to be used for temperature sensing and/or control purposes. Note that the temperature-sensing modbots would normally be part of a modbot that sensed (or controlled) other parameters and performed other tasks. For example, a “light-switch” modbot could also perform thermostat, motion detection, occupancy, lighting leveles, audio, security sensing and control functions, among others.

In some embodiments, all modbots would have the same capabilities as all the other modbots such that the premises central collection point (ISD 30-1A in the case of premises 13-A1, FIG. 1) would gather whatever digital data is required from the various modbots associated with the premises and based on the totality of the information gathered (the digital copy of the premises) initiate and issue commands as necessary to control what needs to be controlled at any point in time. In this manner, the premises operates as a unified whole and does not respond to stimuli coming only from individual sensors.

For example, assume the motion detector(s) in a bedroom report that the room is occupied but that motion in that room has stopped. Also assume that no other motion detectors have reported motion in any other portion of the premises. The system then could assume (of course depending upon time and other parameters set up by the user) that the occupant of the room is sleeping. Then, subsequent motion in that room can be ignored, or otherwise treated as desired by the user.

Now suppose that taken as a whole, the sensors determine that all occupants have left the premises. This can be done in a variety of ways, such as by having an occupant touch a pad on the way out or in, by biometrics or RFID, or near-field detection (or other electronic sensing of the person by a modbot at the various doorways, etc). Now further assume that the totality of the digital image indicates no motion in the premises. Thus, as discussed above, when no motion has been detected for a period of time within the premises the digital copy of the premises would yield a result that the premises is most likely vacant. This, then, becomes the “normal” or expected condition for this period of time. Motion within the premises, without a proper ID of the person entering the premises, (or water flowing, or any other detected activity that is not normally associated with a vacant premises i.e., outside the expected activity) then would result in an abnormal or “trouble” condition which is then handled on a premise-by-premise basis, and/or on a room-by-room or zone-by-zone basis. Zones could be predetermined or created as required and could consist of a combination of areas within rooms, buildings, premises or combinations thereof. Different “normals” or expected conditions can be established for each zone in the premises and these “normals” can change with time, day, temperature, network power requirements, or under any of numerous situations. These expected conditions can be set by the system, by the user, perhaps by a utility, or by a combination thereof.

Also, note that when the premises has been determined to be vacant (or certain portions of the premises are determined to be vacant) the heat/cooling, light levels, etc. could be adjusted accordingly. Also note that the action taken by the local ISD in response to a power adjustment request (whether the request comes from the electric, water, gas, cable or other authority), or in response to changing utility costs on a minute by minute basis can be handled in accordance with the current digital copy of the premises. Garden, yard, golf course, park, athletic field, greenhouse, or agricultural field watering and irrigation cycles as well as outdoor and indoor lighting, among other facility or space operating systems, could be controlled in this manner.

It should be clear that when the system takes a “digital copy” it is aggregating and keeping track of the information coming to it from the sensors presently in the system. Users can add and subtract sensors at any time and thus it would be impossible for any digital copy of a premises, or digital copies of a plurality of premises, to contain every possible sensed parameter one could think up. Rather, a digital copy is useful when enough parameters of concern are being measured so as to produce an intelligent understanding, for purposes either of a holistic understanding or of one or more specific management control interests (such as energy management, or file or security management), of the environment being observed. In any situation or service requirement, the number of monitored sensors will depend upon the specifics of that situation or service requirement and the goals of the premise operator and/or the central control utility and/or service provider.

In operation, let us assume that a premise, such as a house, has distributed around that premise a number of bots 40 as discussed above. The modbots, as discussed, could all have the same function, or they could have different functions. Some could be mounted inside light switch boxes, while others can be plugged into wall outlets or mounted on walls, etc. Some modbots could be associated with a major piece of equipment, such as an air conditioner or a computer, and some could be associated with an appliance, such as a washer, or a dryer, or a refrigerator. A modbot (smart chip) having perhaps a reduced set of measuring and control parameters, could, for example, be imbedded in any number of devices and/or appliances. These imbedded modbots could handle only the appliance or device in which it is imbedded or they could handle additional parameters and control if desired.

The modbots, as discussed above, for a premise, typically would be the same, but certain of them could be designed for specific application and/or service. As discussed, they could determine motion, GPS location, power usage, light levels in a room, etc., as discussed. This then would provide a digital copy of the monitored location for use by the ISD.

The information in each modbot is fed back to the local ISD for processing and aggregation at the ISD. This processing is accomplished under control of a user operated or user-authorized automated program, as well as in response to other information coming to it from, for example, control system 11 (FIG. 1). By way of example, let us assume that a premise ISD, based upon all the information coming to it (motion sensors, power usage, water usage, etc.) determines that no one is currently present at the premise. This could be done based upon the fact that no lights have been turned on or off for a certain period of time, or that the user has gone through a door and set the alarm. At some point in time a modbot associated with, say a water meter, determines that water is flowing in the house. Also assume that modbots associated with each of the water-using mechanisms, such as washer, hot water heater, etc., gives indications that none of those units are being used. The system then under control of the processor and memory in the ISD can make a determination that the water system has malfunctioned. One action that can be taken is to turn off the water to the house. In other situations, an alarm can be sent to an emergency responder via the Internet RF telephone connection or cell phone. All of these actions are taken under control of the ISD, based on data coming from individual modbots working as a unified whole under the ISD supervision for that location. Even without input from water usage bots, the ISD, based simply on water usage (or a light coming on in a room) can determine that this activity is improper because the alarm has not been reset and that the expected condition is that no one should be in the premise.

Another example would be if central control 11 sends a message to the ISD, or to a plurality of ISDs, that it is necessary to reduce power by 10%. The local ISD then, in association with all of the modbots at the premise, determines which applications should be turned off or turned down. The actions taken will be individual to a particular premise and will be based on programs created and authorized for that premise and stored in the ISD to achieve the desired result. For example, it can be that the freezer is turned off for, say, thirty minutes while the house air conditioner continues to function. After thirty minutes, the freezer is turned back on and the air conditioner is turned off for a period of time. In a situation where a building uses heat generated by lights and equipment for heating purposes and uses air conditioning in winter as well as summer to maintain a comfortable environment for inhabitants, it is necessary in winter to turn “up” (allowing the premise to be hotter) the thermostats to conserve power. This in counter intuitive, since in a conventional system the thermostats would be turned “lower” in winter to conserve power. By using a digital copy of the premises for control purposes such improper responses are eliminated. Thus, each premise will have a reduction in power different from other premises, depending upon the specific programmed needs and the condition that each premise finds itself with respect to power usage. This would allow a user to determine that for its particular interest or preference it is better to control the temperature in the house as opposed to changing the refrigeration. Other customers might determine that the first thing that will be turned off are all the TVs, entertainment units, washing and drying equipment or other power equipment, leaving the refrigerator and freezer unchanged. Sometimes with certain equipment a power drain continues even when the device is “off”. In such situations, power can be removed at the plug entry (as opposed to the front panel switch) to achieve the desired and monitored result.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor-readable medium or transmitted by a computer data signal embodied in a carrier wave, or a signal modulated by a carrier, over a transmission medium. The “processor-readable medium” may include any medium that can store or transfer information. Examples of the processor-readable medium include an electronic circuit, a semiconductor memory device, a ROM, a flash memory, an erasable ROM (EROM), a floppy diskette, a compact disk CD-ROM, an optical disk, a hard disk, a fiber optic medium, a powerline carrier medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

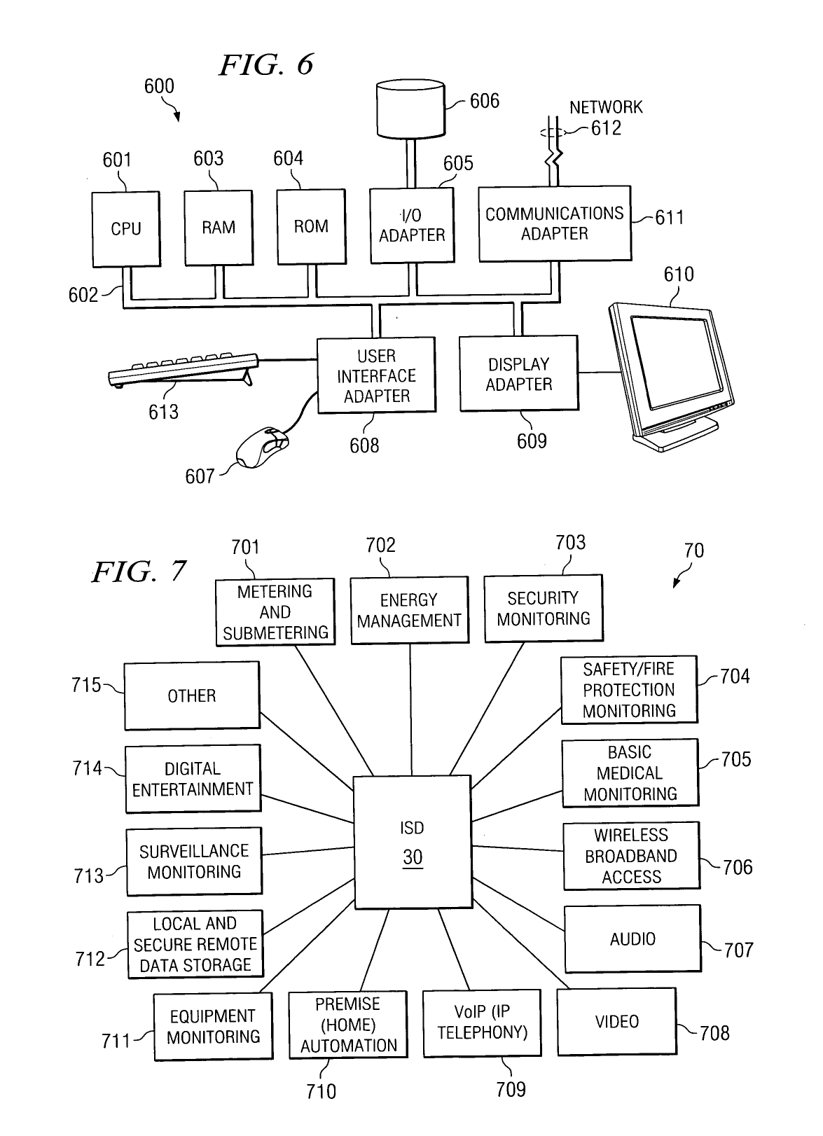

FIG. 6 illustrates computer system 600 adapted to use the present invention. Central processing unit (CPU) XX01 is coupled to system bus 602. The CPU 601 may be any general purpose CPU, such as an HP PA-8500 or Intel Pentium processor. However, the present invention is not restricted by the architecture of CPU 601 as long as CPU 601 supports the inventive operations as described herein. Bus 602 is coupled to random access memory (RAM) XX03, which may be SRAM, DRAM, or SDRAM. ROM 604 is also coupled to bus 602, which may be PROM, EPROM, or EEPROM. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects to storage devices 606, such as one or more of a hard drive, a CD drive, a floppy disk drive, a tape drive, to the computer system. The I/O adapter 605 is also connected to printer 614, which would allow the system to print paper copies of information such as document, photographs, articles, etc. Note that the printer may a printer (e.g. dot matrix, laser, etc.), a fax machine, or a copier machine. Communications card 611 is adapted to couple the computer system 600 to a network 612, which may be one or more of a telephone network, a local (LAN) and/or a wide-area (WAN) network, an Ethernet network, and/or the Internet network. User interface card 608 couples user input devices, such as keyboard 613, pointing device 607, and microphone 616, to the computer system 600. User interface card 608 also provides sound output to a user via speaker(s) 615. The display card 609 is driven by CPU 601 to control the display on display device 610.

It should be noted that when modbot interactions, co-ordinations, aggregations (or disaggregations as necessary or preferred), and controls are directed by the local ISD platform, these platforms, and their interactions, also can be coordinated, aggregated, and controlled. The interaction of modbots and ISDs creates a sensor-equipped society or delegation of intelligent, optimally-controllable loads and devices that serve the various needs of both the local end-user and the service provider.

All manageable devices and their possible users are represented in the interconnected system by partially autonomous, small, smart software programs called delegates which are, in this case, responsible for efficient and optimal use of energy while taking sensor, market, and customer preferences into account. Load model, local load state, time period, duration, market price, total production of the utility, total demand of utility customers, external energy market demand, and consumption predictions may also be included.

Delegates communicate, act, and cooperate as representatives assisting the customer to achieve given goals such as cost-effective real-time power and load management. Delegates also are responsible for numerous other energy and non-energy applications, when so directed.

The communication and cooperation among delegates (which run on modbots, ISDs, and elsewhere and could be incorporated as applications running on each device processor) for the purpose of power management takes the form of a computational market in which delegates, using virtual money, represent buyers and sellers of Distributed Energy Resources (DER), (such as, for example, the modbots), including energy management, distributed generation, distributed energy storage, weather adjusted information (via temperature sensors in modbots), and grid locational/condition information, among other services. Delegates communicate and negotiate, in a free-market bidding-like manner, to achieve the desired objectives of all stakeholders.

Individual delegates have the following properties:

Delegates are autonomous within their hierarchy: Delegates operate without intervention of humans and others, accept input from local sensors, and have control over their internal states, within their hierarchy. Within the hierarchy, delegates can be grouped to meet specific requirements (i.e., security levels).

Delegates must represent someone: At the appropriate juncture in a transaction, delegates must disclose whom they represent.

Delegates must be authorized and registered: Delegates must be authorized and registered to act within the hierarchy.

Delegates must state their objectives: Each delegate must state its high-level objectives, and those objectives must be within the objectives of the hierarchy.

Delegates cannot replicate without representation and registration: Delegates cannot replicate without representation and registration. Each delegate is assigned to represent a specific user and must publish its “user”. As contrasted to agents, for example, computer viruses are agents without representation or registration, and typically they must be eradicated using search and destroy methods.

Delegates are interactive: Delegates interact with local sensors, other delegates, and people.

Delegates are reactive: Delegates perceive their local environment (via local sensors and from other delegates) and respond in a timely fashion to changes that occur in it.

Delegates are proactive: Delegates do not simply act in response to their environment; they also are able to exhibit goal-directed behavior by taking the initiative.

To provide for optimized, changing, system-wide, multi-objective solutions and robustness of result, the concepts discussed herein are based on a centrally-driven hierarchy of multiple, individually cooperating, individually interacting, distributed, optimizing, intelligent software delegates. In contrast to agents, each delegate has the following characteristics and functions:

It is given local objectives that fit within the umbrella of optimized system-wide objectives from the hierarchy above it through robust bi-directional communications. This effectively produces a centrally-dispatchable, de-centrally managed, distributed global control system.

It has an individual, local view of any and relevant challenges, and it accepts local sensor data that can immediately affect the local decision-making process.

It can, with objectives provided from the hierarchy above it, continue to provide high levels of accurate and robust control in the event of a communication breakdown with the delegate above itself.

It automatically interacts hierarchically with other delegates to find a solution that best meets both individual and system/market objectives.

The architecture is designed to perform the following functions:

Adapt to short and long term changes at large and increasing scale, where such changes are only in the supply/demand relation and subsequent transaction, and do not affect system topology, database schemas, or algorithms. Delegates are preprocessed to efficiently provide optimized solutions by a specially packaged version of Optimal's QuixFlow analysis and optimization technology. It is important to note that the formation or change in formation of supply/demand relationships presents difficult coordination issues. Delegates must simultaneously negotiate transactions at multiple levels, with important interdependencies among inputs and outputs at each level. Although this often requires optimization, it does not require a change in system topology, database schemas, or algorithm. In other words, although the data is dynamic, the process itself can be set to definitive software (remotely upgradeable) protocols.

Incorporate transactions which themselves may consist of several messages, which are detailed in the information-exchange topology and data base schemas. This topology and the database schemas are based on algorithms that predefine communication types and patterns and allow the message protocols to be built, updated, distributed, and redistributed in a structured and efficient manner. The system is remotely changeable and upgradeable—system updates do not require end-user or utility personnel input or maintenance.

Simplify the addition and deletion of customers. Again, this is only a change in the supply/demand relation and does not affect system topology, database schemas, or algorithms.

Assure robust and proper functioning and guarantee delivery services even when component parts are not functioning (e.g., network or communication system failure).

Because the delegate receives, or in the event of communications failure has received, instruction from the hierarchy above it, and because it acts on new, locally-gathered sensor data, it continues to function to meet a defendable result based on the instruction(s) from the hierarchy above and continual data from local sensors. Within this context delegates do the following:

Estimate the value of different customer contracts by observing the amount of (virtual) money the different delegates of those contracts have collected. Thus, cost/benefit analysis of the distributed resource is feasible for every single contract. By comparing the money spent by distributed generation delegates vs. load management delegates, it also is possible to determine where individual or aggregated distributed resource management is most important, i.e., in distributed generation, in load management, or in a combination of both. The ability to add and optimize other factors, such as emissions, maintenance, fuel, transmission tariffs, and other risk costs, further enhances this approach.

By incorporating rich and relevant local sensor input and other “incentive signals”, each locally-optimizing delegate can dynamically re-control within its hierarchy to best meet local and system-wide objectives. With this approach, the highest delegate in the hierarchy as it then exists acts like a totally-informed, centralized control algorithm. The use of cooperating delegates automates and encourages beneficial transactions, and lessens system growth problems such as intractable information structures, message delays, and dynamic changes in the system topology. A transaction in this context consists of software delegates informing, requesting, offering, accepting, rejecting, competing with, and assisting one another.

In still other situations the local ISD could determine that the power is likely to be turned down because of events monitored at the local system, and could begin to take those actions even before being instructed to do so. Also, as power becomes sensitive to cost throughout a day, the ISD can keep track of the power costs (on a minute-by-minute basis) and can turn equipment on and off as the price of electricity rises and falls throughout a day to take advantage of lower costs for a consumer. These actions are configurable under control of a processor and memory in the ISD working in conjunction with intermediate distribution point 12 and central control 11 (FIGS. 1 and 2). The ISD communicates its actions to control 11 and thus power consumption across the entire distribution system is known precisely. Also, in some cases where power factor is critical, the ISD, in conjunction with the local modbots, could add or subtract load based on the power factor of the load.

FIG. 7 depicts one embodiment 70 of a platform for the unification of multiple services to and from a premises. As discussed above, once the platform is deployed for one service it can used for multiple services as shown. Elements 701-715 depict some of the services that can be unified for a premises and these can be expanded upon, or combined as desired and can include sensors and/or controls and individual devices, applications, communication equipment, etc. Embodiment 70 is not intended to be an exhaustive list of services but mere representative one.

The unified approach works both inbound to the premises as well as outbound there from and relies on the fact that the central controller, ISD 30—in this case, maintains a coherent view of the premises with respect to environmental conditions, such as power consumption, on a device by device (or zone by zone) basis. Thus, any service provider need only communicate with the ISD to be in communication with any or all of the premises 1 sensors/controllers.

By way of example, if it is desired to install an entertainment center in a guest bedroom there would be no need to run any additional wires or cables since all of the communications connections would be available at the ISD or through modbots in communication with the ISD.

The hardware and software components do not have to be converged by themselves, but will provide a unified view to an outsider. The outsider would see, for example, one or more of: 1) a single integrated hardware platform regardless of how many hardware components are added; 2) a single integrated communications platform, again regardless of how many components are added; 3) an integrated operating system regardless of how many software components are added; and 4) an integrated user interface regardless of how many “views” and how many view-port displays are available or added.

The cohesiveness (unification) should happen at each level, but the actual deliverable to a user would be an expandable platform that maintains its cohesiveness in a unified manner no matter how big or small it becomes.

Without the unified approach to serving a premises (or group of premises), poor or incorrect end-user engagement occurs (as happens currently) resulting in inadequate and unsustainable benefits such as equipment that is too difficult to upgrade, use, or connect to. End-user benefits are non-existent because end-users cannot use the equipment or service using the unified approach sophistication should be hidden from the user, not endured by the user.

Currently, service providers suffer unnecessarily high support costs (back-office, call center, installation, compatibility, etc.) associated with disparate, often numerous devices/vendors necessary to deliver and maintain a typical service. A unified approach eliminates (or at least reduces) the ongoing support costs which often break the business model of the services provider. High support costs are much more important than up-front deployment costs due to the long-lived nature of the installation. Currently, there are too many different interfaces, protocols, operating systems, user displays, communication types, and so called “standards” that need to be included and further supported by a service provider. Using the unified approach discussed herein these overhead costs are reduced significantly.

This platform also provides the ability for automation of home, building, facility, ship, or other space or operation for the user that is fully configurable by the user. For instance, some users might want all the lights turned out if no motion is detected in a room for a certain period of time. Other automation includes functions such as “when the security system is set incoming phone calls are automatically forwarded to a cell phone”. Or, if the security system is set and excess water is being used or excess gas is being used, then the system can turn off the gas or water and alert the user, or if appropriate, alert emergency responders. The different services that are available with the infrastructure that has been created in each premise allows multiple different services available to the user. In addition to increased safety and security, the system also can provide a user telephony control as well as using the intrinsic high speed communications for voice over IP, Internet, audio, video, and high speed Internet connection services, etc. All of these features are placed onto the same system or backbone throughout the premise and provide a low-cost, easy way of managing systems in the premise as well as managing communications.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the service process, system, machine, manufacture, composition of matter, means, methods and steps described in the specification. As one will readily appreciate from the disclosure, services, processes, systems, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such services, processes, systems, machines, manufacture, compositions of matter, means, methods, or steps.

What is claimed is:

1. A monitoring and control system comprising:
a plurality of sensor units spaced apart about a premises, said sensors operative for communicating electrical and environmental conditions concerning a multiplicity of electrical and environmental conditions pertinent to said premises; and
a control unit for aggregating communicated conditions from said sensors, said control unit further operative for communicating control signals in response to an aggregated condition.

2. The monitoring system of claim 1 wherein said communicated control signals are responsive to said aggregated condition for bringing said premises into line with a desired currently normal condition of said premises.

3. The monitoring system of claim 1 wherein said communicated control signals are for the purpose of bringing said premises into balance with a then normal condition established for said premises as determined by said aggregated communicated conditions.

4. The monitoring system of claim 3 wherein said aggregating further comprises receiving information from at least one external service provider, and wherein said aggregating includes taking proper account of information received from said external service provider.

5. The monitoring system of claim 4 wherein said external service provider information is used, at least in part, to establish said then normal premises condition.

6. The monitoring system of claim 1 wherein at least one of said sensors is further operative to monitor and control at least one device associated with said one sensor; and wherein said one sensor controls said one device in accordance with signals communicated from said control unit.

7. The monitoring system of claim 1 wherein said control signals are communicated to at least one external service provider.

8. The monitoring system of claim 1 further comprising:
means for communicating data and control signals between a hierarchy of different premises; and
means for tailoring said communicated data and control signals in accordance with information received from at least one of said other premises.

9. The method set forth in claim 8 further comprising:
means for negotiating among said different premises so as to be able to tailor said communicated control signals in accordance with a holistic view of all of said different premises.

10. The method of claim 9 further comprising:
means for coordinating said negotiations in a pre-established hieratical manner.

11. The method of claim 8 wherein said communicating means has a finite life and a finite relationship with a particular premises.

12. A premise monitoring and control system comprising:
a plurality of individual control units spaced about said premise, each said individual control unit adapted for monitoring one or more selected environmental conditions pertaining to said premise; and
a device for communicating with at least one premise service and with said plurality of individual control units, said device operable for sending instructions to one or more of said individual control units to control service usage at said premise in accordance with information obtained from said service provider and from said local control units and for monitoring the quality and amount of such service usage

13. The premise monitoring and control system of claim 12 wherein said control units monitor the quality and amount of such service usage.

14. The device of claim 13 wherein said service provider is a power utility and wherein said service usage is the consumption of power at said premises.

15. The system of claim 13 wherein said instructions are based upon the current digital copy of said premise as obtained by said device from data from said individual control units.

16. The system of claim 15 further comprising:
an override for manually modifying said instructions.

17. The system of claim 15 wherein said digital copy as of said premise is used to form a display of various monitored electrical and environmental conditions for presentation to a user.

18. The system of claim 17 wherein said display can be used for controlling the electrical and environmental conditions of said premise.

19. The system of claim 15 wherein said digital copy as of said premise is used to form a display of the various externally available services for presentation to a user.

20. The system of claim 19 wherein said display can be used for controlling said services with respect to said premises.

21. The system of claim 13 further comprising:
communications circuitry within at least some of said local control units for facilitating communications to and from said device to said individual control units.

22. The system of claim 15 wherein said communication between said device and said service provider is through at least one intermediate relay point, each said relay point handling a plurality of other premises' devices.

23. The system of claim 15 further comprising:
a device associated with said service provider for creating a digital copy of a plurality of premises based upon digital copies of individual premises as obtained from said plurality of premises.

24. The system of claim 13 wherein said communication between said device and said service provider is selected from at least one of the following: Internet, cellular, wireless, wireline or other guided media, signals over power line.

25. The system of claim 13 wherein said device contains at least one application program, said application program adapted for controlling power with respect to said premise in accordance with a plan uniquely identified with said premise.

26. The system of claim 13 wherein said uniquely identified plan accepts data information from said service provider and conforms the service usage of said premise to said service provider information and wherein said premise device is further operable for confirming service usage consumption back to said service provider.

27. The system of claim 13 wherein service from said service provider is modifiable by a user at said premise from time to time.

28. The system of claim 13 wherein said device contains at least one application program, said application program adapted for controlling power with respect to said premise in accordance with a plan uniquely identified with a plurality of premises.

29. The system of claim 12 wherein at least some of said individual control units are associated with utility inputs to said premise and at least some of said individual control units are associated with particular measurable conditions within said premise;
wherein said device further comprises an application program for determining one or more potential fault conditions within said premise based upon a totality of all measured conditions communicated to said device from said individual input units; and
communicating instructions to at least one of said individual control units associated with a utility input to take a particular action with respect to said associated utility input, said communicated instructions based at least in part upon said determined potential fault conditions.

30. The system of claim 29 wherein none of the conditions reported from said individual control units is necessarily a fault condition when taken independent from other of said reported conditions.

31. The system of claim 29 further comprising:
an override for allowing manual modification of a fault condition.

32. The system of claim 27 wherein said utility inputs are selected from the list of: electricity, gas, water, telephone, building management services, entertainment services, security services, Internet, fire, medical monitoring services, other alarm services, cable, wireless port, steam, sewer; and
wherein said measurable conditions are selected from the list of: electrical parameters, temperature, light, motion, sound, GPS location, occupancy, biometrics, medical monitoring, humidity, radiation, hazardous chemicals and gases, pollutants, (vapor, chemical, particle, gas, etc.), materials residues, entertainment systems, smoke and fire detection, water flow, water presence, audio, video.

33. The system of claim 12 wherein said device is further operable for sending information to said service provider pertaining to the instructions sent to said local control units with respect to service usage at said premises.

34. The system of claim 12 wherein said device is further operable for sending information to said service provider pertaining to the current status of service usage at said premises as determined from the totality of said communications between said device and said premises individual control units.

35. A method for controlling energy usage at a premise, said method comprising:
gathering a digital copy of said premises from devices distributed throughout said premise;
receiving at least one parameter with respect to a power grid serving said premise; and
determining for said premise a preferred set of adjustments to be made at said premise to optimize said premise in accordance with received ones of said parameters, said optimization based upon the then current gathered digital copy of said premise.

36. The method of claim 35 further comprising:
controlling from time to time equipment at said premise in accordance with said determined optimization.

37. The method of claim 36 wherein said gathering, said receiving and said determining are all performed on a per premise basis using at least one device dedicated to said premise.

38. The method of claim 36 wherein said gathering, said receiving and said determining are all performed on a per premise basis using at least one device serving a plurality of premises.

39. The method of claim 36 wherein each said device is operable for detecting electrical environmental parameters at and/or controlling various premise equipment.

40. The method of claim 36 wherein each said device is further operational for communications with one or more other devices to facilitate said gathering and said controlling.

41. The method of claim 36 further comprising:
determining adjustments that should be taken with respect to said premises based upon a determined deviation from an acceptable digital copy of said premises; and
wherein said controlling further comprises:
controlling said premises equipment in accordance with said last-mentioned determined adjustments.

42. The method of claim 41 further comprising:
from time to time adjusting the parameters of said acceptable digital copy.

43. The method of claim 41 further comprising:
from time to time adjusting the adjustment that is to be made based upon a determined deviation from an acceptable digital copy of said premises.

44. A system comprising:
means for capturing a digital copy of a premises to be monitored, said digital copy comprising parameters selected from the list of: electrical parameters, temperature, light level, motion, sound, GPS location, occupancy, biometrics, medical condition detection, entertainment systems, smoke and fire detection, pollutants, (vapor, chemical, particle, gas, etc.), materials residues, humidity, radiation, water flow, and water presence;
means for determining from time to time when a captured digital copy of a premises, when taken as a whole, deviates from an established expected condition; and
means controlled at least in part by said determining means for taking action with respect to said premises, said action selected from the list of: sending an alarm signal, modifying the electrical power consumption of said premise, modifying the water consumption usage of said premise, modifying the gas consumption of said premises, modifying the entertainment usage of said premises, modifying the power factor of said premises, modifying the utility consumption of said premises, providing video or audio or readable directions and information regarding response to or modification of monitored conditions, providing instructions to a monitored patient as to what pills to take when a condition is identified; instructions or alert to a homeowner that an appliance is in need of servicing, a visual display of said premise, said display reflecting said digital copy.

45. The system of claim 44 further comprising:
means for allowing a premises user to control, at least in part, said established expected conditions.

46. The system of claim 45 further comprising:
means for communicating with a utility serving said premises to obtain utility parameters; and
wherein said obtained utility parameters are a factor controlling said established expected conditions.

47. The system of claim 46 further comprising:
means spaced about said premises for communicating said parameters.

48. The system of claim 47 wherein said communications is by using a hopping and mesh communication network among said spaced apart means and said capturing means.

49. The system of claim 44 wherein said utility communicating means comprises:
means for communicating to said utility at least a portion of said digital copy of said premises.

50. The system of claim 44 wherein said utility communicating means comprises:
means for communicating to said utility actions taken at said premise or premises in accordance with said obtained parameters.

51. A method comprising:
capturing a digital copy of a premises to be monitored, said digital copy comprising parameters selected from the list of: electrical parameters, temperature, light level, motion, sound, GPS location, occupancy, biometrics, medical condition detection, entertainment systems, smoke and fire detection, hazardous chemicals or gases, radiation, pollutants, (vapor, chemical, particle, gas, etc.), humidity, water flow, water presence;
determining from time to time when a captured digital copy of a premises, when taken as a whole, deviates from an established expected condition; and
taking action with respect to said premises based upon said determining, said action selected from the list of: sending an alarm signal, modifying the electrical power consumption of said premises, or one or more devices, appliances, or systems of said premises modifying the water consumption usage of said premises, modifying the gas consumption of said premises, modifying the entertainment usage of said premises, modifying the security functions of said premises, modifying the emergency response and/or evacuation functions of said premises, modifying the power factor of said premises, modifying the utility consumption of said premises; and
providing video or audio or readable directions and information regarding response to or modification of monitored conditions providing video or audio or readable directions and information regarding response to or modification of monitored conditions, providing instructions to a monitored patient as to what pills to take when a condition is identified; instructions or alert to a homeowner that an appliance is in need of servicing.

52. The method of claim 51 further comprising:
allowing a premises user to control, at least in part, said established expected conditions.

53. The method of claim 51 further comprising:
communicating with a utility serving said premises to obtain utility parameters; and
wherein said obtained utility parameters are a factor controlling said established expected conditions.

54. The method of claim 51 further comprising:
obtaining said premises parameters from spaced apart sensors.

55. The method of claim 54 further comprising:
communicating among said spaced apart sensors by using a hopping and mesh communication network among said spaced apart sensors.

56. The method of claim 51 further comprising:
communicating to said utility at least a portion of said digital copy of said premises.

57. The method of claim 51 further comprising:
communicating to said utility actions taken at said premise or premises in accordance with said obtained parameters.

58. A system comprising:
a device for capturing a digital copy of at lease one of a plurality of premises to be monitored, said digital copy comprising parameters selected from the list of: electrical parameters, temperature, light level, motion, sound, GPS location, occupancy, biometrics, medical condition detection, entertainment systems, smoke and fire detection, hazardous chemicals and gases, radiation, pollutants (vapor, chemical, particle, gas), humidity, water flow, water presence, utility consumption;
a processor for determining from time to time when a captured digital copy of a premises, when taken as a whole, deviates from an established expected condition at said premises; and
controllers operative in response to commands from said processor for taking action to adjust said captured digital copy of said premise, said action selected from the list of: changing the lighting level of particular locations of said premises, changing the temperature of selected locations within said premises, modifying the security functions of said premises changing the outdoor lighting of said premises, changing any watering pattern of said premises; and
providing video or audio or readable directions and information regarding response to or modification of monitored conditions.

59. The system of claim 58 wherein said controllers are further operative to report conditions associated with said premises, said conditions selected from the list of: electrical parameters, temperature, light level, motion, sound, GPS location, occupancy, biometrics, medical condition detection, entertainment systems, smoke and fire detection, hazardous chemicals and gases, radiation, pollutants (vapor, chemical, particle, gas) humidity, water flow, water presence.

60. The system of claim 59 wherein said controllers communicate with said processor over a network selected from the list of wireline, signals over guided media, signals over electrical media, Internet, wireless; and
means spaced about said premises for communicating said parameters.

61. The system of claim 60 wherein said communications is by using a hopping and mesh communication network among said controller and said processor.

62. A method for community control comprising:
creating at each premises in a community a digital copy of individual premise; and
interacting among said premises to control the utilization by said community of at least one shared service based upon an interaction of all of said individual digital copies.

63. The method of claim 62 wherein said shared service is electricity usage.

64. The method of claim 62 wherein said interacting is in a predetermined hierarchy.

65. The method of claim 62 wherein said interacting is under control of applications individually associated with devices at various locations at each said premise.

66. A unitary service platform comprising:
a plurality of sensor units spaced apart about a premises, said sensors operative for communicating electrical and environmental conditions concerning a multiplicity of electrical and environmental conditions pertinent to said premises;
a control unit for aggregating communicated conditions from said sensors;
a plurality of interfaces for communicating between said control unit and at least one service provider; and
wherein a control unit for aggregating communicated conditions from said sensors said control unit is further operative for communicating control signals to select one of said service providers in response to an aggregated condition.

67. The unitary service platform of claim 66 wherein said communicated control signals are responsive to signals delivered to said control unit from ones of said service providers.

68. The unitary service platform of claim 67 wherein said communicated control signals are communicated to selected ones of said sensors based on signals from selected ones of said service providers.

69. The unitary service platform of claim 68 wherein said aggregating further comprises receiving information from said service providers, and wherein said aggregating includes taking proper account of information received from all of said service providers.

70. The unitary service platform of claim 69 wherein said service provider's information is used, at least in part, to establish a normal premises condition.

71. A unitary service platform comprising:
a plurality of sensor units spaced apart about a premises, said sensors operative for communicating end-user settings for a wide variety of services;
a control unit for aggregating communicated conditions from said sensors;
a plurality of interfaces for communicating between said control unit and at least one service provider; and
wherein said control unit is further operative for communicating control signals to select one of said service providers in response to an aggregated condition.

72. The unitary service platform of claim 71 wherein said aggregating further comprises receiving information from said service providers, and wherein said aggregating includes taking proper account of information received from all of said service providers.

73. The unitary service platform of claim 72 wherein said service provider's information is used, at least in part, to establish a normal premises condition.

74. The unitary service platform of claim 71 wherein said services are selected from the list including: electrical parameters, data parameters, communication parameters, security, surveillance, monitoring, temperature, running times and duration, light, motion, sound, GPS location, occupancy, biometrics, medical monitoring, humidity, radiation, hazardous chemicals and gases, pollutants, (vapor, chemical, particle, gas, etc.), materials residues, audio, video, entertainment systems, smoke and fire detection, water flow, water presence, automation.
